(19) United States
(12) Patent Application Publication
(10) Pub. No.: US 2026/0342930 A1
(43) Pub. Date: Oct. 29, 2026

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: KAZUKI KADO, Kanagawa (JP)

(21) Appl. No.: 19/654,711

(22) Filed: Apr. 22, 2026

(30) Foreign Application Priority Data
Apr. 24, 2025 (JP) 2025-072472

(51) Int. Cl. H04N 1/44; H04N 1/00; H04L 9/40

(52) U.S. Cl. CPC H04N 1/4413; H04N 1/00464; H04N 1/4426; H04L 63/083; H04N 1/00244; H04N 2201/0094

(57) ABSTRACT

Provided is an information processing apparatus configured to be communicably connected with an image formation apparatus and including a web browser, including: at least one memory and at least one processor which function as: an acceptance unit configured to accept input of user information to the web browser for remote login to the image formation apparatus; a transmission unit configured to perform control to transmit the user information accepted by the acceptance unit to the image formation apparatus for local login to the image formation apparatus that allows the remote login; and a display control unit configured to perform control to display a first screen, which is a screen displayed on a display unit of the image formation apparatus that allows the local login based on the user information, on the web browser.

### BACKGROUND

### Field of the Technology

The present disclosure relates to an information processing apparatus, a control method of the information processing apparatus, and a storage medium.

### Description of the Related Art

There has been a function called a remote operation for operating a display unit of an apparatus from a remote location. A literature (Japanese Patent Laid-Open No. 2024-160774) discloses a technique in which a special authority for a user is set in advance in an image formation apparatus having the remote operation function, and thus the access to the image formation apparatus is automatically executed in a case of remotely operating the image formation apparatus from an information processing apparatus.

There has been a demand for a technique that lessens an operation load for the user in a case of the access from the information processing apparatus to the image formation apparatus, thereby improving the convenience.

### SUMMARY

An information processing apparatus according to an aspect of the present disclosure is the information processing apparatus configured to be communicably connected with an image formation apparatus and including a web browser, including: at least one memory and at least one processor which function as: an acceptance unit configured to accept input of user information to the web browser for remote login to the image formation apparatus; a transmission unit configured to perform control to transmit the user information accepted by the acceptance unit to the image formation apparatus for local login to the image formation apparatus that allows the remote login; and a display control unit configured to perform control to display a first screen, which is a screen displayed on a display unit of the image formation apparatus that allows the local login based on the user information, on the web browser.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of a system;

FIG. 2 is a diagram illustrating an example of a hardware configuration of an image formation apparatus;

FIG. 3 is a diagram illustrating an example of a software configuration of the image formation apparatus;

FIG. 4 is a diagram illustrating an example of a hardware configuration of an information processing apparatus;

FIG. 5 is a diagram illustrating an example of a software configuration of the information processing apparatus;

FIG. 6A is a flowchart illustrating an example of processing of displaying a login screen of a remote UI that is executed by the information processing apparatus as a function of a web browser;

FIG. 6B is a flowchart illustrating an example of processing of displaying a screen of the remote UI executed by the image formation apparatus as a function of a web server;

FIG. 7 is a diagram illustrating an example of the login screen of the remote UI;

FIG. 8 is a diagram illustrating an example of a setting screen on which setting related to a remote operation can be performed;

FIG. 9 is a diagram illustrating an example of a setting value of the remote operation setting;

FIG. 10A is a flowchart illustrating an example of processing executed by the information processing apparatus as a function of the web browser;

FIG. 10B is a flowchart illustrating an example of processing executed by the image formation apparatus as a function of the web server;

FIG. 10C is a flowchart illustrating an example of processing executed by the image formation apparatus as a function of the web server;

FIG. 11 is a diagram illustrating an example of an error screen;

FIG. 12 is a diagram illustrating an example of a top screen of the remote UI;

FIG. 13 is a diagram illustrating an example of a screen to confirm whether to utilize a remote operation function;

FIG. 14 is a diagram illustrating an example of a remote operation screen;

FIG. 15 is a diagram illustrating an example of a management table to manage a user name and a flag indicating whether remote UI is already logged in;

FIG. 16A is a flowchart illustrating an example of processing executed by the information processing apparatus as a function of the web browser;

FIG. 16B is a flowchart illustrating an example of processing executed by the image formation apparatus as a function of the web server;

FIG. 16C is a flowchart illustrating an example of processing executed by the image formation apparatus as a function of the web server;

FIG. 17A is a flowchart illustrating an example of processing executed by the information processing apparatus as a function of the web browser;

FIG. 17B is a flowchart illustrating an example of processing executed by the image formation apparatus as a function of the web server;

FIG. 17C is a flowchart illustrating an example of processing executed by the image formation apparatus as a function of the web server;

FIG. 18A is a flowchart illustrating an example of processing executed by the information processing apparatus as a function of the web browser;

FIG. 18B is a flowchart illustrating an example of processing executed by the image formation apparatus as a function of the web server;

FIG. 18C is a flowchart illustrating an example of processing executed by the image formation apparatus as a function of the web server;

FIG. 19 is a diagram illustrating an example of a setting screen related to local login in a case of the remote operation;

FIG. 20 is a diagram illustrating an example of a warning screen; and

FIG. 21 is a diagram illustrating an example of a local login screen.

### DESCRIPTION OF THE EMBODIMENTS

Hereinafter, preferred embodiments of the present disclosure are described in detail with reference to the appended drawings. Note that, the following embodiments are not intended to limit the matters of the present disclosure, and not all the combinations of characteristics described in the following embodiments are necessarily required for the means for solving the problems of the present disclosure. Note that, the same configurations are denoted by the same reference numerals and described.

There is a function called a remote operation for operating a display unit of an apparatus from a remote location. This is implemented by using software called Virtual Network Computing (VNC). The VNC is formed of server software and client software.

For example, in a case of performing the remote operation on an image formation apparatus having a function of a VNC server, the server software is activated in advance on an image formation apparatus side, and the client software is activated on an information processing apparatus side, which operates an operation panel of the image formation apparatus. Then, the information processing apparatus activating the client software is connected to the VNC server of the image formation apparatus, and thus it is possible to remotely operate the operation panel of the image formation apparatus. In order to establish the communication between the VNC server and the information processing apparatus, a Remote Framebuffer (RFB) protocol (RFC 6143) is used. Thus, with the server software being activated in advance in the image formation apparatus, it is possible to remotely operate the image formation apparatus from the information processing apparatus by using the client software.

Additionally, in a case of the information processing apparatus including a web browser, it is possible to remotely operate the image formation apparatus also by being connected to the image formation apparatus via the web browser and being connected to the VNC server of the image formation apparatus via a web server.

In the above-described image formation apparatus, in order to limit users who can access the image formation apparatus, it is possible to adopt user authentication (login authentication). Additionally, it is possible to allocate a function that can be utilized for each user (for example, copy inhibition, all functions available, or the like). In addition, in the above-described image formation apparatus, it is possible to adopt a personalization function (displaying a personal address book of the user who logs in and the like). Thus, it is possible to identify the utilizable functions of the image formation apparatus depending on the allocated authority of the users.

A technique in which a special authority for the user is set in advance in the image formation apparatus having a remote operation function, and thus the access to the image formation apparatus is automatically executed in a case of remotely operating the image formation apparatus from the information processing apparatus has been known. However, in the above-described technique, it is necessary to set the special authority for the user in advance. For this reason, it is impossible to access easily from the information processing apparatus to the image formation apparatus without the above-described prior setting, and in some cases, it is necessary to perform a user operation multiple times to access the image formation apparatus.

In the following embodiments, a technique in which the access to the image formation apparatus is automatically performed based on user information stored in the web browser of the information processing apparatus, and thus it is possible to lessen the operation load for the user and improve the convenience is described.

### First Embodiment

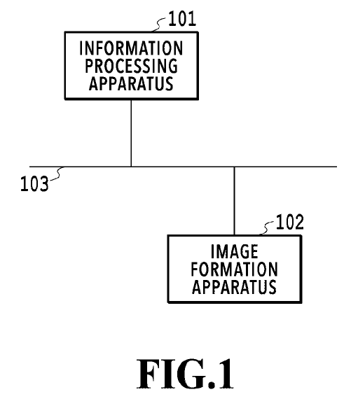

FIG. 1 is a diagram illustrating an example of a configuration of a system in the present disclosure. The system illustrated in FIG. 1 includes an information processing apparatus 101 and an image formation apparatus 102. The information processing apparatus 101 and the image formation apparatus 102 are communicably connected to each other via a network 103.

An example in which the network 103 in the present disclosure is a wired Local Area Network (LAN) is described. Note that, the network 103 may be a wireless LAN or a Wide Area Network (WAN).

An example in which the information processing apparatus 101 in the present disclosure is a PC is described; however, the information processing apparatus 101 may be a tablet terminal, a smartphone, or the like. Additionally, the information processing apparatus 101 includes a general web browser. In the system illustrated in FIG. 1, a single information processing apparatus is illustrated; however, multiple information processing apparatuses may be included.

In the present disclosure, an example in which the image formation apparatus 102 includes a web server function and a VNC server function is described. Note that, the image formation apparatus 102 may include no web server function nor VNC server function. That is, the web server and the VNC server may exist as a separate device from the image formation apparatus 102.

The image formation apparatus 102 can provide a function of a remote UI to the information processing apparatus 101 via the web server. The remote UI is software that provides functions such as browsing of a status of the image formation apparatus 102, operation of a job, and various types of setting of the image formation apparatus 102. Additionally, the image formation apparatus 102 can provide a function that makes it possible to operate an operation unit of the image formation apparatus 102 via the web server and the VNC server to the information processing apparatus 101 for each user.

Here, allowing the information processing apparatus 101 to log into the remote UI and allowing the user of the information processing apparatus 101 to log into the operation unit of the image formation apparatus 102, which are executed by image formation apparatus 102, are described.

The login to the remote UI is the access to the remote UI along with the user authentication. From the time the access to the remote UI is allowed to the information processing apparatus 101 until the ending of the access (hereinafter, referred to as logging in the remote UI), it is possible to display a top screen of the remote UI via the web browser, which is described later, in the information processing apparatus 101.

The login to the operation unit of the image formation apparatus 102 is the access that makes it possible to operate the operation unit of the image formation apparatus 102 (hereinafter, referred to as local login). From the time the local login by the user of the information processing apparatus 101 is allowed until logout (hereinafter, referred to as in the local login), it is possible to operate the operation unit of the image formation apparatus 102 from the information processing apparatus 101 via the VNC server. Thus, the user of the information processing apparatus 101 can utilize the function of the image formation apparatus 102 by remotely operating the operation unit of the image formation apparatus 102. In the present disclosure, an example in which the image formation apparatus 102 maintains a local login state of a single user at once is described. Note that, a first user can operate the operation unit of the image formation apparatus 102 from the information processing apparatus 101 not only in a case where the first user is in the local login but also in a case where the second user is already in the local login.

After the activation of the image formation apparatus 102, the image formation apparatus 102 activates the web server and the VNC server. Then, the image formation apparatus 102 waits for a request from the information processing apparatus 101. The user of the information processing apparatus 101 displays a login screen of the remote UI of the image formation apparatus 102 on the web browser by inputting a predetermined Uniform Resource Locator (URL) to the web browser described later. Specifically, once the predetermined URL is inputted to the web browser by the user, the information processing apparatus 101 transmits the request corresponding to the URL to the image formation apparatus 102. As a response to the request from the information processing apparatus 101, the image formation apparatus 102 transmits an HTML corresponding to the predetermined URL and web page data written in a script language or the like to the information processing apparatus 101. Then, based on the received web page data, the web browser forms and displays the login screen of the remote UI. The communication between the image formation apparatus 102 and the web browser is established according to a Hypertext Transfer Protocol (HTTP) protocol.

Once the login screen of the remote UI is displayed on the web browser, the user of the information processing apparatus 101 inputs the user information such as a user name and a password to the screen. Then, the information processing apparatus 101 stores the inputted user information and transmits the user information to the image formation apparatus 102. Based on the received user information, the image formation apparatus 102 performs the user authentication, and based on the authentication result, the image formation apparatus 102 allows the information processing apparatus 101 to log into the remote UI.

In a case where the login to the remote UI is allowed, the information processing apparatus 101 displays the top screen of the remote UI on the web browser. Then, the information processing apparatus 101 detects the user operation performed on the top screen of the remote UI, and in a case where predetermined requirements are satisfied, the information processing apparatus 101 requests the image formation apparatus 102 to allow the local login. The image formation apparatus 102 allows the information processing apparatus 101, which makes the request, to perform the local login in response to the request for the local login. Then, VNC connection processing for the remote operation is started between the web browser and the image formation apparatus 102. In the VNC connection processing, the web browser communicates with the VNC server via the web server of the image formation apparatus 102. In the communication with the VNC server, handshake processing is executed first. In the handshake processing, information is transmitted between the VNC server and the image formation apparatus 102 to establish the VNC connection. After the VNC connection is established, the VNC server transmits information such as a display screen and a screen operation of the image formation apparatus 102 to the web browser.

In a case where the local login is allowed, the information processing apparatus 101 displays a remote operation screen on the web browser. The user of the information processing apparatus 101 can remotely operate the image formation apparatus 102 via the web browser.

In the image formation apparatus 102, the user authentication (login authentication) to limit the users who can log into the remote UI (in some cases, expressed as remote login) is executed. In the present disclosure, an example in which, once the image formation apparatus 102 executes the user authentication (login and logout), the authentication result is transmitted to the information processing apparatus 101 is described. Note that, the user authentication may be executed by the information processing apparatus 101. For example, in a case where the image formation apparatus 102 receives the request for the login to the remote UI from the information processing apparatus 101, the image formation apparatus 102 transmits the authentication information related to the user authentication held by itself to the information processing apparatus 101. Then, the information processing apparatus 101 may execute the user authentication based on the received authentication information and the user information stored by itself.

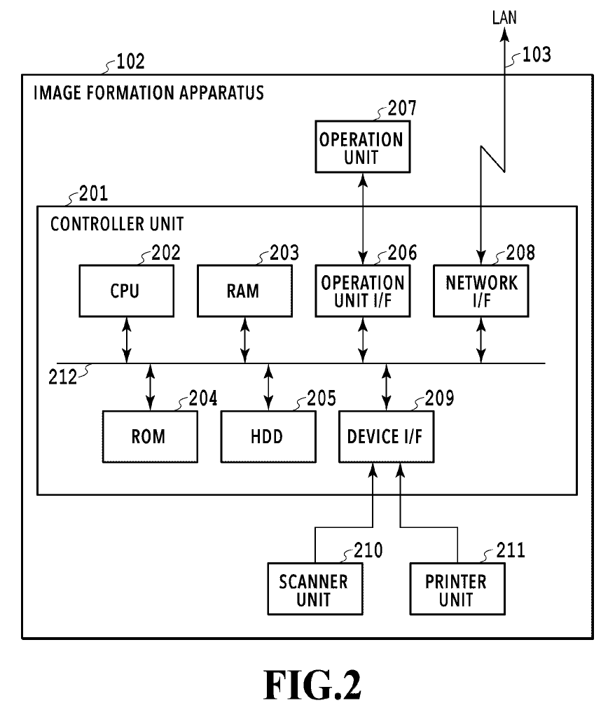

FIG. 2 is a diagram illustrating an example of a hardware configuration of the image formation apparatus 102 in the present disclosure. The image formation apparatus 102 includes a controller unit 201, an operation unit 207, a scanner unit 210, and a printer unit 211.

The controller unit 201 includes a CPU 202, a RAM 203, a ROM 204, an HDD 205, an operation unit interface (I/F) 206, a network I/F 208, and a device I/F 209. These constituents are connected to each other via a system bus 212.

The CPU 202 is a calculation device that controls overall the image formation apparatus 102. The ROM 204 is a non-volatile memory. The ROM 204 stores image data and other data, various programs to allow the CPU 202 to operate, and the like.

The RAM 203 is a volatile memory that is a main memory of the CPU 202 and is used as a temporal storage region such as a working area. Additionally, the RAM 203 is a storage region into which a program such as an operating system, system software, and application software, various data, and the like are loaded.

The CPU 202 implements various functions of the image formation apparatus 102 by loading the program stored in the ROM 204 and the like into the RAM 203 and executing the program. Note that, the program that allows the CPU 202 to operate is not limited to that stored in the ROM 204, and a program that is stored in advance in the hard disk drive (HDD) 205 and the like may be used.

The HDD 205 stores the operating system, the system software, and the application software, the image data and setting data, and the like. Note that, as long as it is possible to store the data, the device is not limited to the HDD 205, and another storage device such as an SSD, an SD memory card, or an EMMC may be used.

The operation unit I/F 206 is an interface unit for the operation unit 207 and outputs information to be displayed on the operation unit 207 to the operation unit 207. Additionally, the operation unit I/F 206 accepts information inputted to the operation unit 207 by the user. The operation unit 207 includes a touch panel and a hardware key to accept the user operation. The touch panel is a panel formed in a flat shape, and coordinate information touched by the user is notified from the operation unit 207 to the operation unit I/F 206. The hardware key is a key that can be physically pressed such as a numerical value key, a start key, and a stop key, and in a case where the key is pressed, information indicating the key is notified from the operation unit 207 to the operation unit I/F 206. Additionally, the operation unit 207 includes a display that displays an image. The display receives a Graphical User Interface (GUI) screen generated by the CPU 202 from the operation unit I/F 206 and displays the GUI screen. With the integral formation of the touch panel with an upper layer of the display, the CPU 202 can perform control as if the user directly operated the screen displayed on the display.

The network I/F 208 is connected to the network 103 and performs transmission and reception of the information to and from the information processing apparatus 101 connected on the same LAN. The device I/F 209 is connected to the scanner unit 210, which is an input and output device of the image data, and the printer unit 211, which performs an image formation operation on a printing medium. The device I/F 209 performs transmission and reception of the image data, a control signal, and the like to and from the scanner unit 210 and the printer unit 211.

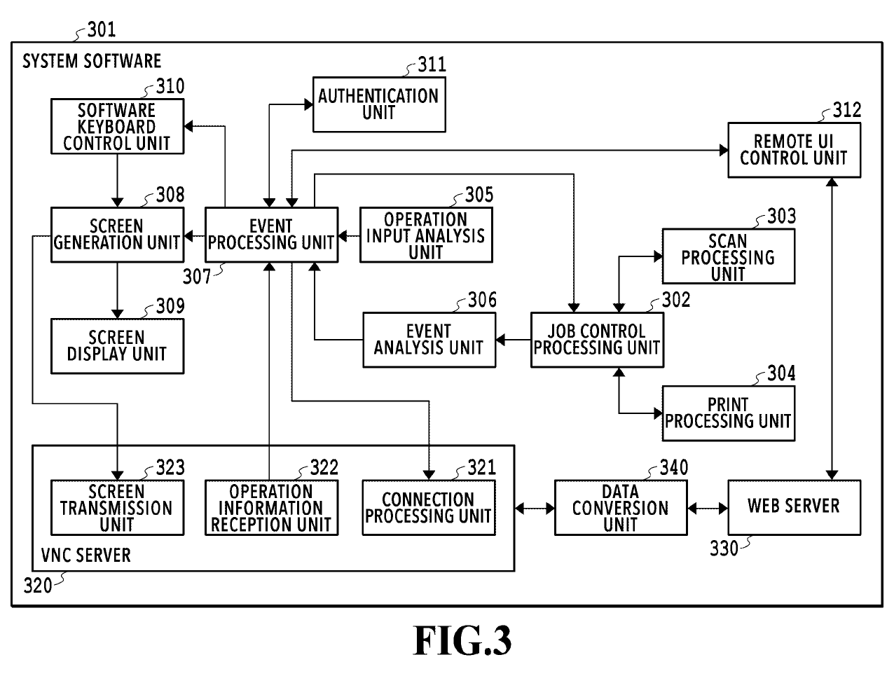

FIG. 3 is a diagram illustrating an example of a software configuration of the image formation apparatus 102 in the present disclosure. The image formation apparatus 102 includes system software 301 illustrated in FIG. 3. The system software 301 is stored in a storage device that is any one of the RAM 203, the ROM 204, and the HDD 205 and is executed by the CPU 202.

The system software 301 includes a job control processing unit 302, a scan processing unit 303, a print processing unit 304, an operation input analysis unit 305, an event analysis unit 306, an event processing unit 307, a screen generation unit 308, and a screen display unit 309. The system software 301 includes a software keyboard control unit 310, an authentication unit 311, a remote UI control unit 312, a VNC server 320, a web server 330, and a data conversion unit 340. The VNC server 320 includes a connection processing unit 321, an operation information reception unit 322, and a screen transmission unit 323.

The job control processing unit 302 implements the function of the image formation apparatus 102 such as copy, print, and scan by controlling each software module including a not-illustrated software module.

The scan processing unit 303 performs processing of reading an original document placed on a platen of the scanner unit 210 by controlling the scanner unit 210 by way of the device I/F 209 based on an instruction of the job control processing unit 302.

The print processing unit 304 performs image formation processing based on the image data by controlling the printer unit 211 by way of the device I/F 209 based on the instruction of the job control processing unit 302.

The operation input analysis unit 305 analyzes the information supplied from the operation unit 207 via the operation unit I/F 206 and notifies the event processing unit 307 of an event according to the user operation corresponding to the analysis result. The user operation corresponding to the analysis result obtained by the operation input analysis unit 305 is, for example, the user operation performed on the operation unit 207, which includes touching the touch panel by the user, pressing the hardware key by the user, and the like.

The event analysis unit 306 analyzes various events that occur in the image formation apparatus 102, other than the user operation performed on the operation unit 207, received from the job control processing unit 302 and the like and notifies the event processing unit 307 of the event corresponding to the analysis result. The event corresponding to the analysis result obtained by the event analysis unit 306 includes, for example, completion of the started processing, a shortage of the printing medium, and the like.

The event processing unit 307 receives the event from the operation input analysis unit 305, the event analysis unit 306, the operation information reception unit 322, and the like. Depending on the received event, the event processing unit 307 notifies the job control processing unit 302, the screen generation unit 308, or the software keyboard control unit 310 of the event and controls the image formation apparatus 102. Additionally, the event processing unit 307 notifies the authentication unit 311 of the information (for example, the user information and the like) received from the operation input analysis unit 305 or the remote UI control unit 312 and receives a result of the user authentication from the authentication unit 311. Moreover, the event processing unit 307 notifies the connection processing unit 321 of disconnection of the VNC connection.

The authentication unit 311 manages the authentication information related to the user authentication and provides various authentication services in cooperation with the event processing unit 307. The authentication unit 311 performs the user authentication processing by receiving the user information from the event processing unit 307 and returns the result. For example, in response to the request for the login to the remote UI by way of the web server 330, the authentication unit 311 performs the user authentication processing for each request. Then, in a case where the user authentication succeeds, the authentication unit 311 allows the information processing apparatus, which makes the request for the login to the remote UI, to perform web connection to the image formation apparatus 102. Additionally, once the authentication unit 311 is notified of the event of disconnection of the web connection from the event processing unit 307, the authentication unit 311 performs processing of ending the access to the remote UI. Moreover, in response to a local login request, the authentication unit 311 performs the user authentication processing for the local login by the apparatus that makes the request depending on whether there is already the user in the local login. Then, in a case where the user authentication for the local login succeeds, or in a case where a VNC connection request is received, the authentication unit 311 allows the information processing apparatus 101 to perform the VNC connection to the image formation apparatus 102.

Furthermore, the authentication unit 311 can perform the authentication processing of the user of the image formation apparatus 102 also for the event by way of the operation unit I/F 206. In a case of power saving, the authentication unit 311 can perform logout processing of the user who is allowed by the authentication processing and who is being logged in.

The screen generation unit 308 performs processing of generating data of the screen to be displayed on the display on the RAM 203. The screen display unit 309 reads the data of the screen generated by the screen generation unit 308 from the RAM 203 and displays the screen on the display of the operation unit 207 via the operation unit I/F 206. The software keyboard control unit 310 performs control to display a software keyboard screen in response to the notification from the event processing unit 307. Additionally, the software keyboard control unit 310 holds information indicating whether the software keyboard is being displayed on the display.

The VNC server 320 is a software module having a function for performing the remote operation of the operation unit 207 from the information processing apparatus 101. The VNC server 320 performs transmission and reception of information related to the remote operation to and from the data conversion unit 340.

The connection processing unit 321 accepts the VNC connection request via the data conversion unit 340 and performs the VNC connection processing. Additionally, once the connection processing unit 321 is notified of the disconnection of the VNC connection from the event processing unit 307, the connection processing unit 321 performs the disconnection of the VNC connection.

The operation information reception unit 322 receives VNC operation information via the data conversion unit 340 and notifies the event processing unit 307 of the event according to the received operation information. Note that, the event notified by the operation information reception unit 322 is similar to the event notified by the operation input analysis unit 305 and is the event corresponding to the user operation performed on the image formation apparatus 102.

The screen transmission unit 323 performs processing of reading screen data generated by the screen generation unit 308 from the RAM 203 and passing the screen data to the data conversion unit 340. Additionally, in a case where not-illustrated VNC client software is installed in the information processing apparatus 101, the VNC server 320 can also establish communication with the VNC client software via the network 103.

The web server 330 receives an HTTP request, which is transmitted by a web browser 502 operating in the information processing apparatus 101, via the network 103. Then, the web server 330 performs analysis of the received data and requests the remote UI control unit 312 or the data conversion unit 340 to perform the processing depending on the analysis result. Specifically, in a case where the received data is related to the VNC as a result of the data analysis, the web server 330 requests the data conversion unit 340 to perform the processing, and in a case other than the above, the web server 330 requests the remote UI control unit 312 to perform the processing. Alternatively, the web server 330 receives a response from the remote UI control unit 312 or the data conversion unit 340. Then, the web server 330 transmits the received response to the web browser 502 via the network 103.

The remote UI control unit 312 receives the request for the processing from the web server 330. Then, the remote UI control unit 312 makes a notification to the event processing unit 307 according to the received request. Additionally, in response to the notification from the event processing unit 307, the remote UI control unit 312 responds to the web server 330. The data conversion unit 340 performs transmission and reception of the information related to the VNC to and from each of the web server 330 and the VNC server 320.

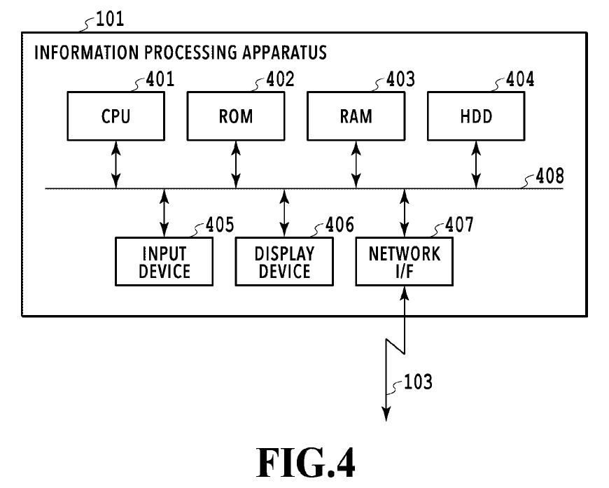

FIG. 4 is a diagram illustrating an example of a hardware configuration of the information processing apparatus 101 in the present disclosure. The information processing apparatus 101 includes a CPU 401, a ROM 402, a RAM 403, an HDD 404, an input device 405, a display device 406, and a network I/F 407. These constituents are connected to each other via a system bus 408.

The CPU 401 is a calculation device that controls overall the information processing apparatus 101. The ROM 402 is a non-volatile memory. The ROM 402 stores the image data and other data, various programs to allow the CPU 401 to operate, and the like.

The RAM 403 is a volatile memory that is a main memory of the CPU 401 and is used as a temporal storage region such as a working area. Additionally, the RAM 403 is a storage region into which the program such as the operating system, the system software, and the application software, various data, and the like are loaded.

The CPU 401 implements various functions of the information processing apparatus 101 by loading the program stored in the ROM 402 and the like into the RAM 403 and executing the program. Additionally, the CPU 401 implements a function (or processing) by the operating system or an application by executing the processing based on the program corresponding to the operating system or the application stored in the HDD 404. Note that, the program that allows the CPU 401 to operate is not limited to that stored in the ROM 402, and a program that is stored in advance in the HDD 404 and the like may be used.

The HDD 404 stores the operating system, the system software, and the application software, a photograph, an electronic document, and the setting data, and the like. Note that, as long as it is possible to store the data, the device is not limited to the HDD 404, and another storage device such as an SSD, an SD memory card, or an EMMC may be used.

The input device 405 is a keyboard or a pointing device that accepts instruction input to the information processing apparatus 101 by the user. The display device 406 displays information indicating an operation status of the information processing apparatus 101, information outputted by each program operating on the information processing apparatus 101, and the like. The network I/F 407 is connected to the network 103 and performs transmission and reception of the information to and from another information processing apparatus and the image formation apparatus 102 connected on the same LAN.

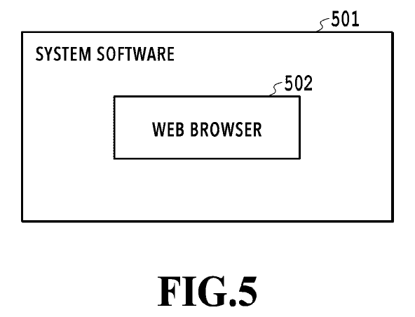

FIG. 5 is a diagram illustrating an example of a software configuration of the information processing apparatus 101 in the present disclosure. System software 501 illustrated in FIG. 5 is stored in a storage device that is any one of the RAM 403, the ROM 402, and the HDD 404 and is executed by the CPU 401. The system software 501 includes the web browser 502.

The web browser 502 requests the web server 330 to obtain web contents. The web browser 502 provides a function of analyzing the Hyper Text Markup Language (HTML) of the web contents obtained from the web server 330 and performing display control in which control to display a screen and the like based on the analysis result on the display device 406 is performed. Additionally, the web browser 502 provides a function of accepting the user information and the like via the screen being displayed. In addition, the web browser 502 provides a function of analyzing and executing JavaScript (registered trademark) and the like. The system software 501 may include the not-illustrated VNC client software. The VNC client software establishes communication with the VNC server 320 via the network 103.

Hereinafter, details of processing that is executed by the information processing apparatus 101 or the image formation apparatus 102 and is to allow the user to remotely operate the operation unit 207 of the image formation apparatus 102 via the web browser 502 are described. First, processing in which the information processing apparatus 101 displays the login screen of the remote UI by the user using the web browser 502 of the information processing apparatus 101 is described.

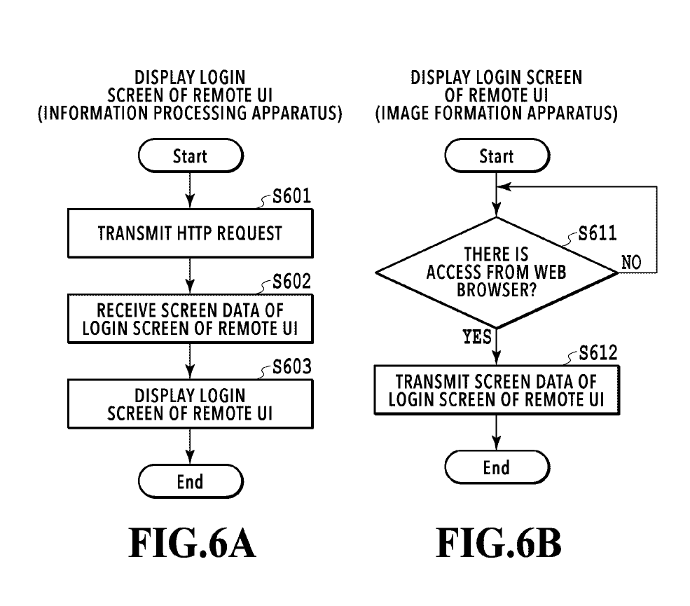

FIG. 6 is a flowchart illustrating an example of processing of displaying the login screen of the remote UI executed by each of the information processing apparatus 101 and the image formation apparatus 102. FIG. 6A is a flowchart illustrating an example of processing of displaying the login screen of the remote UI executed by the CPU 401 of the information processing apparatus 101 as a function of the web browser 502. The processing illustrated in FIG. 6A is implemented with the CPU 401 of the information processing apparatus 101 reading out the program stored in the ROM 402 to the RAM 403, and the CPU 401 executing the program. Note that, a part of or all the functions in steps in FIG. 6A may be implemented by hardware such as an ASIC, an electronic circuit, or the like. A sign "S" in the description of each processing means that it is a step in the flowchart (hereinafter, the same applies to the flowcharts in the present specification). The processing illustrated in FIG. 6A is started with the user inputting a URL (for example, an IP address) of the image formation apparatus 102 to the web browser 502. In this process, for example, the user inputs the URL to the web browser 502 by using the input device 405 such as the pointing device or the keyboard while looking at the display device 406.

In S601, by the web browser 502, once the CPU 401 detects that the URL of the image formation apparatus 102 is inputted, the CPU 401 transmits the HTTP request to the web server 330 indicated by the inputted URL, and the processing proceeds to S602.

In S602, by the web browser 502, the CPU 401 receives the screen data of the login screen of the remote UI from the web server 330 as a response to the HTTP request transmitted in S601, and the processing proceeds to S603.

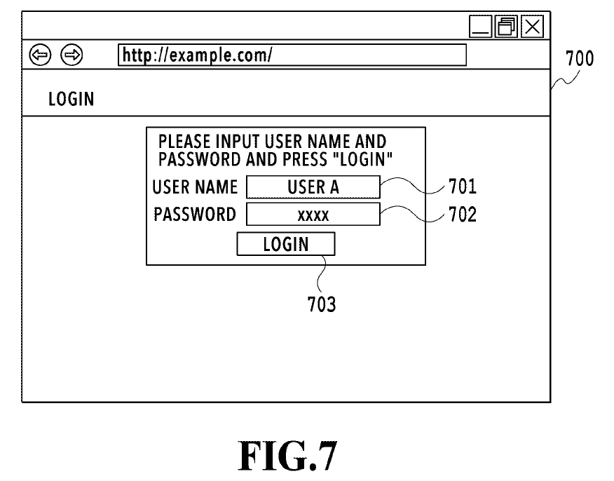

In S603, by the web browser 502, the CPU 401 analyzes the screen data received in S602, displays the login screen of the remote UI on the display device 406 as the analysis result, and ends the present flow. The login screen of the remote UI displayed in S603 is a screen as illustrated in FIG. 7.

FIG. 7 is a diagram illustrating an example of the login screen of the remote UI. A login screen 700 illustrated in FIG. 7 displays a user name input region 701 and a password input region 702. Additionally, the login screen 700 is provided with a login button 703. The login button 703 is a button to accept an instruction to transmit the request for the login to the remote UI.

FIG. 6B is a flowchart illustrating an example of processing of displaying the screen of the remote UI executed by the CPU 202 of the image formation apparatus 102 as a function of the web server 330. The processing illustrated in FIG. 6B is started by activating the web server 330. For example, once the image formation apparatus 102 is powered on by the user of the image formation apparatus 102, a not-illustrated system of the image formation apparatus 102 activates the VNC server 320 and the web server 330.

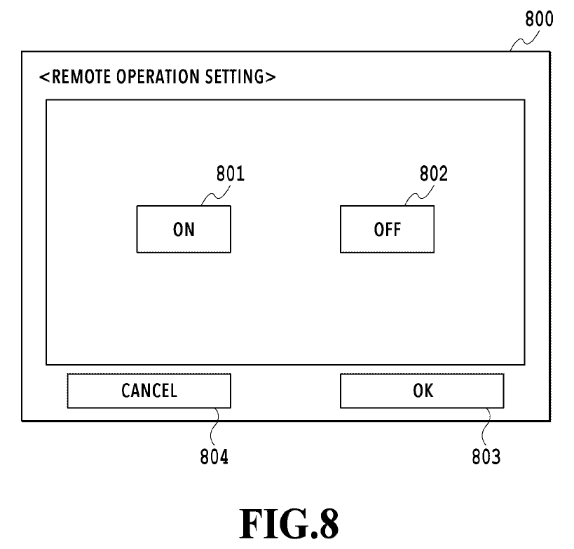

Here, in the activation processing of the VNC server, the connection processing unit 321 determines whether remote operation setting, which is described later, is enabled (ON). The setting related to the remote operation may be set in advance by a manager of the image formation apparatus 102 or may be set in an arbitrary timing. The manager of the image formation apparatus 102 performs the setting related to the remote operation by using a setting screen 800 as illustrated in FIG. 8, for example.

FIG. 8 is a diagram illustrating an example of the setting screen on which the setting related to the remote operation can be performed. The setting screen 800 illustrated in FIG. 8 is a screen displayed on the display by operating the operation unit 207 of the image formation apparatus 102. The manager of the image formation apparatus 102 can set whether to enable or disable the VNC connection on the setting screen 800.

The setting screen 800 is provided with an ON button 801, an OFF button 802, an OK button 803, and a cancel button 804. The ON button 801 is a button to accept the setting to enable the VNC connection. The OFF button 802 is a button to accept the setting to disable the VNC connection. The OK button 803 is a button to determine the setting selected by the ON button 801 or the OFF button 802. The cancel button 804 is a button to accept canceling of the setting selected by the ON button 801 or OFF button 802. Additionally, once the cancel button 804 is pressed, the setting screen 800 is closed.

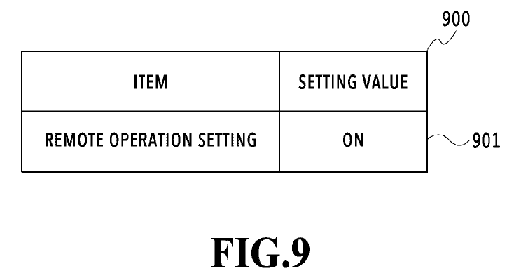

For example, once the manager of the image formation apparatus 102 presses the OK button 803 in a state in which the ON button 801 is being selected, the CPU 202 saves a setting value corresponding to the ON button 801 into the HDD 205. Specifically, the CPU 202 saves the setting value by using a table 900 illustrated in FIG. 9.

FIG. 9 is a diagram illustrating an example of the setting value of the remote operation setting saved in the HDD 205. For example, once the OK button 803 is pressed in a state in which the ON button 801 is being selected, as illustrated in FIG. 9, "ON" is saved in the HDD 205 as a setting value 901. On the other hand, once the OK button 803 is pressed in a state in which the OFF button 802 is being selected, "OFF" is saved in the HDD 205 as the setting value 901. Note that, the present setting value can be referred to by the CPU 202 in an arbitrary timing.

In a case where the setting value 901 of the remote operation setting is enabled (ON), the connection processing unit 321 opens a port for the VNC connection and waits for the VNC connection request from the information processing apparatus 101. In a case where the setting value 901 of the remote operation setting is disabled (OFF), the connection processing unit 321 may open the port for the VNC connection after the setting value 901 is enabled (ON) and may wait for the VNC connection request from the information processing apparatus 101.

Note that, the same may apply to the web server 330, and a configuration in which whether to use the web server 330 can be set by using a not-illustrated setting screen of the web server 330 may be applied. In this case, the setting value is saved in the HDD 205. Then, in the activation processing of the web server 330, the web server 330 may refer to the setting value saved in the HDD 205, may open the port of the web server 330 in a case where the setting value is enabled (ON), and may wait for the access from the web browser 502.

Referring back to FIG. 6B, in S611, the CPU 202 determines whether there is the access from the web browser 502 by the web server 330. In S611, by the web server 330, if it is determined that there is the access from the web browser 502 (Yes), the CPU 202 allows the processing to proceed to S611. For example, in S611, by the web server 330, in a case where the CPU 202 receives the HTTP request from the web browser 502, it is determined that there is the access from the web browser 502.

In S611, by the web server 330, if it is determined that there is no access from the web browser 502 (No), the CPU 202 waits until there is the access from the web browser 502.

In S612, by the web server 330, the CPU 202 requests the remote UI control unit 312 to perform the processing of the HTTP request received in S611. In S612, by the remote UI control unit 312, if it is determined that the HTTP request received in S611 is the request for the login screen of the remote UI, the CPU 202 passes the screen data of the login screen of the remote UI to the web server 330. In S612, by the web server 330, the CPU 202 transmits the screen data of the login screen of the remote UI received from the remote UI control unit 312 to the web browser 502 and ends the present flow.

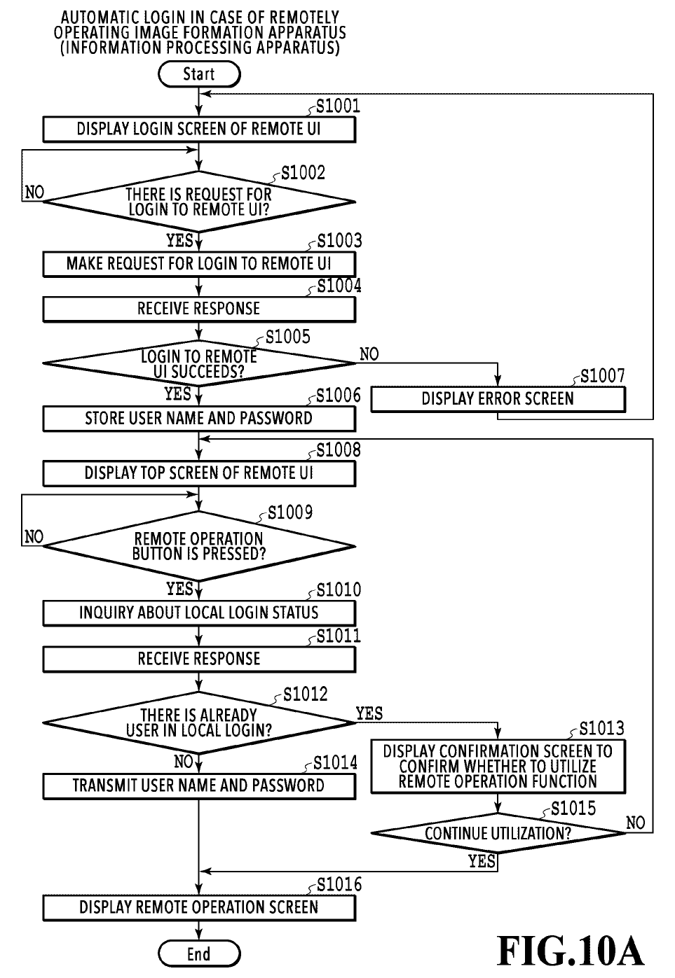

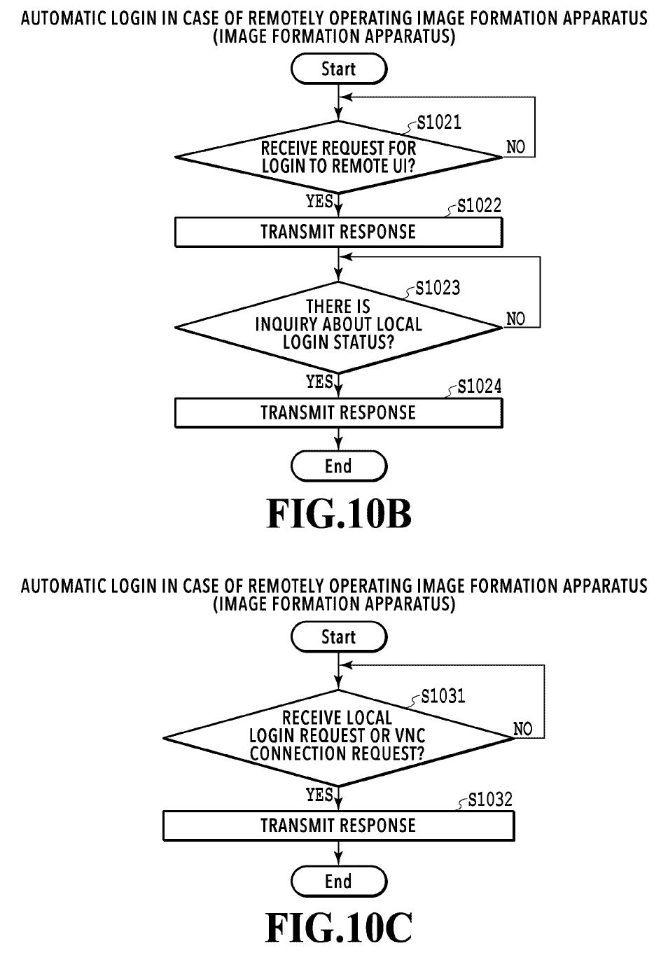

FIG. 10 is a flowchart illustrating an example of processing executed by the information processing apparatus 101 or the image formation apparatus 102 in the present embodiment. With reference to FIG. 10, processing of allowing the local login without inputting the user name (in some cases, expressed as a user ID), the password, and the like after the login to the remote UI.

FIG. 10A is a flowchart illustrating an example of processing executed by the CPU 401 of the information processing apparatus 101 as a function of the web browser 502. The processing illustrated in FIG. 10A is started by the CPU 401 of the information processing apparatus 101 with the user inputting the URL (for example, the IP address) of the image formation apparatus 102 to the web browser 502. A specific operation to input the URL of the image formation apparatus 102 to the web browser 502 by the user is as described above; for this reason, description thereof is omitted.

In S1001, by the web browser 502, the CPU 401 displays the login screen 700 of the remote UI, and the processing proceeds to S1002. That is, the processing in S1001 corresponds to the processing in S603 in FIG. 6A.

In S1002, by the web browser 502, the CPU 401 determines whether the instruction to transmit the request for the login to the remote UI is accepted. For example, in S1002, by the web browser 502, in a case where the login button 703 on the login screen 700 is pressed by the user, the CPU 401 may determine that the instruction to transmit the request for the login to the remote UI is accepted. Alternatively, in a case where the login button 703 is pressed in a state in which the user name is inputted in the user name input region 701, and the password is inputted in the password input region 702, the CPU 401 may determine that the instruction to transmit the request is accepted.

In S1002, by the web browser 502, if it is determined that the instruction to transmit the request for the login to the remote UI is accepted (Yes), the CPU 401 allows the processing to proceed to S1003. In S1002, by the web browser 502, if it is determined that the instruction to transmit the request for the login to the remote UI is not accepted (No), the CPU 401 waits until the instruction to transmit the request is accepted.

In S1003, by the web browser 502, the CPU 401 makes a request to the image formation apparatus 102 for the login to the remote UI while including character strings inputted in the user name input region 701 and the password input region 702, and the processing proceeds to S1004. In the present embodiment, an example in which the user name and the password are transmitted is described. The request for the login to the remote UI is transmitted to the image formation apparatus 102 as the HTTP request.

In S1004, by the web browser 502, the CPU 401 receives a response to the request for the login to the remote UI made in S1003 from the image formation apparatus 102, and the processing proceeds to S1005.

In S1005, by the web browser 502, if the response result received in S1004 indicates that the login to the remote UI succeeds (Yes), the CPU 401 allows the processing to proceed to S1006. In S1005, by the web browser 502, if the response result received in S1004 does not indicate that the login to the remote UI succeeds (No), that is, if it is indicated that the login to the remote UI fails, the CPU 401 allows the processing to proceed to S1007.

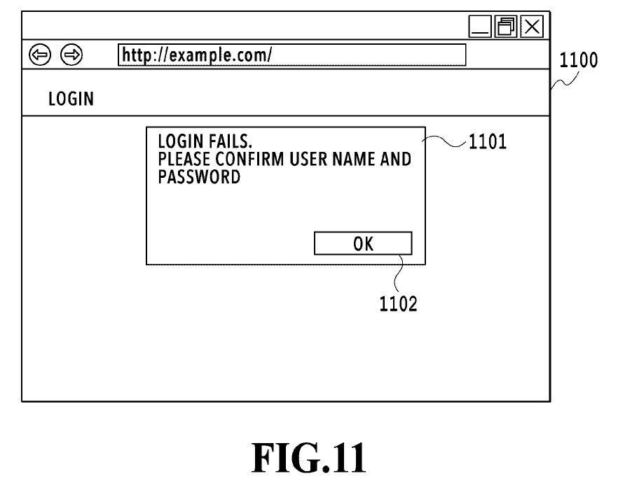

In S1007, by the web browser 502, the CPU 401 displays an error screen as illustrated in FIG. 11. FIG. 11 is a diagram illustrating an example of the error screen displayed on the web browser 502 in a case where the login to the remote UI fails. An error screen 1101 illustrated in FIG. 11 displays a message indicating that the login to the remote UI fails. For example, the error screen 1101 displays a message of "Login fails. Please confirm user name and password." Additionally, the error screen 1101 is provided with an OK button 1102 to accept closing the screen. By the web browser 502, in a case where the CPU 401 detects a pressing operation performed on the OK button 1102 by the user, the processing proceeds to S1001, and the login screen 700 is displayed.

In S1006, by the web browser 502, the CPU 401 stores the user name and the password, and the processing proceeds to S1008. For example, the user name and the password are stored in a storage region such as the RAM 403 or the HDD 404 allocated for the web browser 502 or the system software 501. A combination of the user name and the password stored in S1005 is the user information in a case where the login to the remote UI succeeds. An example in which the user information that is the user name and the password stored in S1005 is discarded in a timing of disconnection of the web connection of the remote UI is described. Note that, even in a case where the web connection of the remote UI is disconnected, the user information may be held by the web browser 502 or the system software 501.

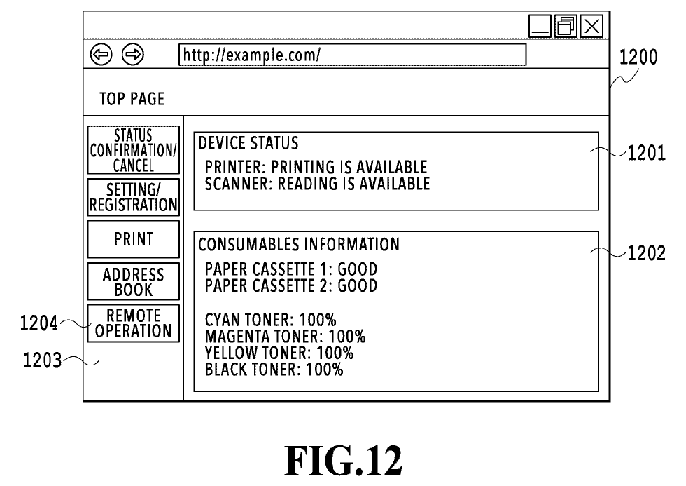

In S1008, by the web browser 502, the CPU 401 displays the top screen of the remote UI as illustrated in FIG. 12, and the processing proceeds to S1009. FIG. 12 is a diagram illustrating an example of the top screen of the remote UI displayed on the web browser 502 in a case where the login to the remote UI succeeds. A top screen 1200 of the remote UI illustrated in FIG. 12 is a screen that can browse a state of the image formation apparatus 102. The top screen 1200 includes a display region 1201 displaying a state of the scanner unit 210 and the printer unit 211 of the image formation apparatus 102 and a display region 1202 displaying information of consumables. The top screen 1200 includes a display region 1203 provided with a button group to accept transition to each page corresponding to the function that can be provided by the image formation apparatus 102. The display region 1203 is provided with a remote operation button 1204 to utilize the remote operation function. That is, the remote operation button 1204 is a button to invoke the remote operation function. The remote operation button 1204 may be displayed in a case where the remote operation setting is enabled (ON).

In S1009, by the web browser 502, the CPU 401 determines whether the remote operation button 1204 is pressed by the user. In S1009, by the web browser 502, if it is determined that the remote operation button 1204 is pressed by the user (Yes), the CPU 401 allows the processing to proceed to S1010. In S1009, by the web browser 502, if it is determined that the remote operation button 1204 is not pressed by the user (No), the CPU 401 waits until the remote operation button 1204 is pressed by the user.

In S1010, by the web browser 502, the CPU 401 inquires of the image formation apparatus 102 about a local login status, and the processing proceeds to S1011. The inquiry about the local login status is an inquiry about whether there is already the user in the local login. The inquiry about the local login status is transmitted to the image formation apparatus 102 as the HTTP request.

In S1011, by the web browser 502, the CPU 401 receives a response to the inquiry about the local login status made in S1010 from the image formation apparatus 102, and the processing proceeds to S1012.

In S1012, by the web browser 502, if the response result received in S1011 indicates that there is already the user in the local login (Yes), the CPU 401 allows the processing to proceed to S1013. In S1012, by the web browser 502, if the response result received in S1011 indicates that there is no user in the local login (No), the CPU 401 allows the processing to proceed to S1014.

In S1014, by the web browser 502, the CPU 401 makes the request to the image formation apparatus 102 for the local login while including the user information such as the user name and the password stored in S1006. Then, in S1014, by the web browser 502, in a case where a response to the local login request is received from the image formation apparatus 102, the CPU 401 allows the processing to proceed to S1016. The local login request is transmitted to the image formation apparatus 102 as the HTTP request.

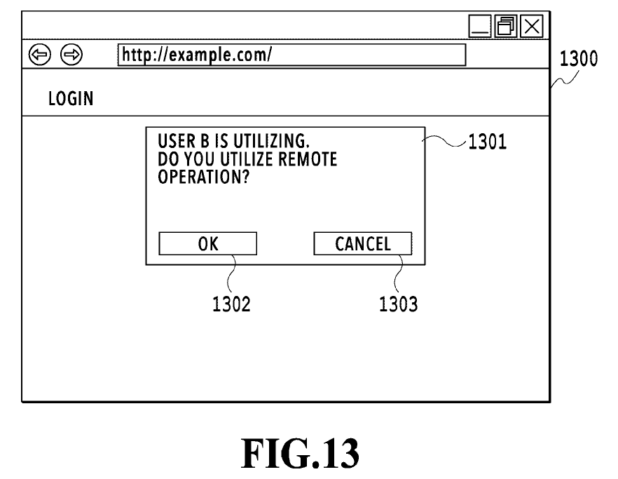

In S1013, by the web browser 502, the CPU 401 displays a confirmation screen as illustrated in FIG. 13, and the processing proceeds to S1015. FIG. 13 is a diagram illustrating an example of a screen displayed on the web browser 502 in a case where there is already the user in the local login and is a screen to confirm whether to utilize the remote operation function by the VNC connection. A confirmation screen 1300 illustrated in FIG. 13 is pop-up displayed to overlap the top screen 1200, for example. The confirmation screen 1300 displays a message indicating that there is already the user in the local login. Specifically, in a case where a user B is in the local login, the confirmation screen 1300 displays a message of "User B is utilizing. Do you utilize remote operation?" Additionally, the confirmation screen 1300 is provided with an OK button 1302 and a cancel button 1303. The OK button 1302 is a button to accept the establishment of the VNC connection while maintaining the login state of the user already in the local login. The cancel button 1303 is a button to accept the cancellation of the VNC connection. In a case where either one of the OK button 1302 and the cancel button 1303 is pressed by the user, the confirmation screen 1300 is closed.

In S1015, by the web browser 502, the CPU 401 determines whether to continue the utilization. For example, in S1015, by the web browser 502, if the CPU 401 detects that the OK button 1302 on the confirmation screen 1300 displayed in S1013 is pressed by the user, it is determined to continue the utilization (Yes). In S1015, by the web browser 502, if the CPU 401 detects that the cancel button 1303 on the confirmation screen 1300 displayed in S1013 is pressed by the user, it is determined not to continue the utilization (No).

In S1015, by the web browser 502, if it is determined to continue the utilization (Yes), the CPU 401 makes the request to the image formation apparatus 102 for the VNC connection, and the processing proceeds to S1016. In S1015, by the web browser 502, if it is determined not to continue the utilization (No), the CPU 401 allows the processing to proceed to S1008.

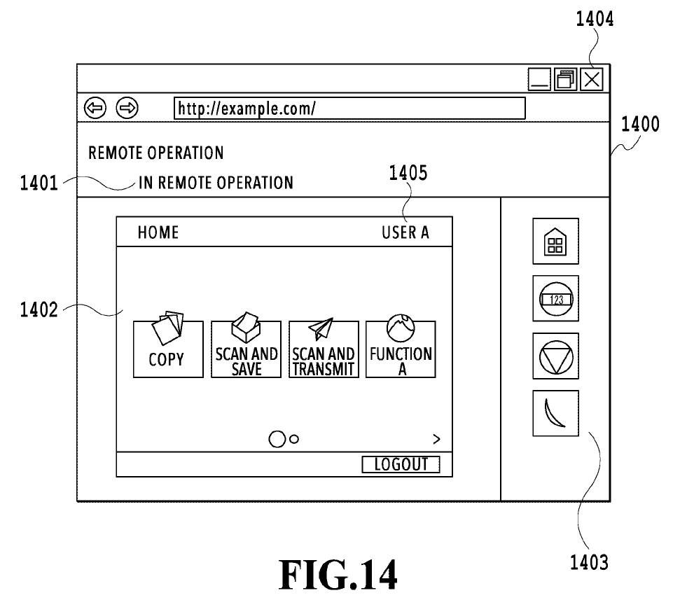

In S1016, by the web browser 502, the CPU 401 displays the remote operation screen as illustrated in FIG. 14 and ends the present flow. FIG. 14 is a diagram illustrating an example of the remote operation screen displayed on the web browser 502 after the VNC connection is established. A remote operation screen 1400 illustrated in FIG. 14 may be displayed by updating the display of the top screen 1200 or the confirmation screen 1300 of the remote UI or may be displayed as another tab or another window.

The remote operation screen 1400 displays a message 1401 indicating a usage state of the remote operation. The remote operation screen 1400 displays a VNC screen 1402. The VNC screen 1402 is a screen provided from the VNC server 320 and is a screen displayed on the operation unit 207 of the image formation apparatus 102. The VNC screen 1402 displays a user name 1405 of the user in the local login. For example, in a case where the remote operation screen 1400 is displayed by way of S1014, that is, in a case where the local login is allowed based on the user information of the user A, "user A" is displayed in the user name 1405. In a case where the remote operation screen 1400 is displayed by way of S1015, that is, in a case where the VNC connection is started in a state in which there is already the user B who is in the local login, "user B" is displayed in the user name 1405.

The remote operation screen 1400 includes an operation key display region 1403. The operation key display region 1403 displays a software key button having the same function as that of the hardware key provided to the operation unit 207. For example, the operation key display region 1403 displays a button to transition to the home screen, a button to transition to a predetermined screen, a button to stop an operation that is in execution in the image formation apparatus 102, a button to cause the image formation apparatus 102 to transition to a power-saving state, and the like. In a case where a × button 1404 provided on the screen of the web browser 502 is pressed, the remote operation screen 1400 is closed, and the web connection and the VNC connection of the remote UI are disconnected. In the present disclosure, an example in which the local login state is maintained even in a case where the × button 1404 is pressed is described. Note that, the local login state may transition to a logout state in a case where the × button 1404 is pressed.

FIG. 10B is a flowchart illustrating an example of processing executed by the CPU 202 of the image formation apparatus 102 as the function of the web server 330. The processing illustrated in FIG. 10B is started by activating the web server 330.

In S1021, by the web server 330, the CPU 202 determines whether the request for the login to the remote UI is received from the web browser 502. In S1021, by the web server 330, if it is determined that the request for the login to the remote UI is received from the web browser 502 (Yes), the CPU 202 allows the processing to proceed to S1022. In S1021, by the web server 330, if it is determined that the request for the login to the remote UI is not received from the web browser 502 (No), the CPU 202 waits until the request for the login to the remote UI is received.

In S1021, by the web server 330, in a case where the request for the login to the remote UI is received from the web browser 502, the CPU 202 makes a notification to the authentication unit 311 via the remote UI control unit 312 and the event processing unit 307. The authentication unit 311 performs the user authentication based on the user information received from the web browser 502 and determines whether to allow the login to the remote UI. Then, the authentication unit 311 passes the result of the user authentication to the web server 330.

In S1022, by the web server 330, the CPU 202 transmits the result of the user authentication received from the authentication unit 311 as a response to the request for the login to the remote UI to the web browser 502, and the processing proceeds to S1023. In a case where the login to the remote UI is allowed, in S1022, by the web server 330, the CPU 202 transmits information indicating that the user authentication succeeds and the screen data of the top screen 1200 of the remote UI to the web browser 502. In a case where the login to the remote UI is not allowed, in S1022, by the web server 330, the CPU 202 transmits information indicating that the user authentication fails and the screen data of the error screen 1101 of the remote UI to the web browser 502.

In S1023, by the web server 330, the CPU 202 determines whether the inquiry about the local login status is received from the web browser 502. In S1023, by the web server 330, if it is determined that the inquiry about the local login status is received from the web browser 502 (Yes), the CPU 202 allows the processing to proceed to S1024. In S1023, by the web server 330, if it is determined that the inquiry about the local login status is not received from the web browser 502 (No), the CPU 202 waits until the inquiry about the local login status is received.

In S1023, by the web server 330, in a case where the inquiry about the local login status is received from the web browser 502, the CPU 202 makes a notification to the authentication unit 311 via the remote UI control unit 312 and the event processing unit 307. The authentication unit 311 determines whether there is already the user in the local login. Then, the authentication unit 311 passes the determination result to the web server 330.

In S1024, by the web server 330, the CPU 202 transmits the determination result received from the authentication unit 311 in S1023 to the web browser 502, which makes the inquiry in S1023, as a response and ends the present flow. In a case where there is already the user in the local login, in S1024, by the web server 330, the CPU 202 transmits information indicating that there is already the user in the local login and the screen data of the confirmation screen 1300 to the web browser 502. In a case where there is no user in the local login, in S1024, by the web server 330, the CPU 202 transmits information indicating that there is no user in the local login to the web browser 502.

FIG. 10C is a flowchart illustrating an example of processing executed by the CPU 202 of the image formation apparatus 102 as a function of the web server 330. The processing illustrated in FIG. 10C is started by activating the web server 330.

In S1031, by the web server 330, the CPU 202 determines whether the local login request or the VNC connection request is received from the web browser 502. In S1031, by the web server 330, if it is determined that the local login request or the VNC connection request is received from the web browser 502 (Yes), the CPU 202 allows the processing to proceed to S1032. In S1031, by the web server 330, if it is determined that no local login request nor VNC connection request is received from the web browser 502 (No), the CPU 202 waits until the local login request or the VNC connection request is received.

In S1031, by the web server 330, in a case where the local login request is received from the web browser 502, the CPU 202 makes a notification to the authentication unit 311 via the data conversion unit 340, the VNC server 320, and the event processing unit 307. The authentication unit 311 performs the user authentication based on the user information received from the web browser 502 and determines whether to allow the local login. Then, the authentication unit 311 passes the result of the user authentication to the web server 330. Note that, in the present disclosure, an example in which the authentication information used for the user authentication in the local login and the authentication information used for the user authentication in the login to the remote UI are the same is described. That is, an example in which the user authentication result obtained by the authentication unit 311 in S1031 allows the local login is described.

In addition, in a case where the local login is allowed or in a case where the VNC connection request is received, the processing of the VNC connection is performed. Once the connection processing unit 321 accepts the VNC connection request from the data conversion unit 340, the VNC connection processing of the information processing apparatus 101, which makes the local login request or the VNC connection request in S1031, is executed. The VNC connection processing is publicly-known processing based on the RFB protocol (RFC 6143); for this reason, detailed description is omitted.

In S1032, by the web server 330, the CPU 202 transmits a response to the local login request or the VNC connection request received in S1031 to the web browser 502, which makes the request, and ends the present flow. In this case, in S1032, by the web server 330, the CPU 202 transmits the screen data of the remote operation screen 1400 with the VNC screen 1402 provided from the VNC server 320 to the web browser 502.

According to the present embodiment, the image formation apparatus automatically performs the local login based on the user information stored by the web browser of the information processing apparatus in a case of the login to the remote UI. Thus, it is possible to lessen the operation load for the user and improve the convenience.

### Second Embodiment

In the first embodiment, an example in which the user information formed of the combination of the user name and the password inputted by the user in a case of the login to the remote UI is stored by the web browser 502 is described. Note that, the user information stored by the web browser 502 is not limited thereto. For example, the user information may be a combination of the user name and information indicating whether the login to the remote UI succeeds (hereinafter, referred to as the remote UI is already logged in). In the present embodiment, an example in which, in a case of requesting the local login, the information processing apparatus 101 transmits the information indicating whether the remote UI is already logged in, instead of the password, to the image formation apparatus 102 is described.

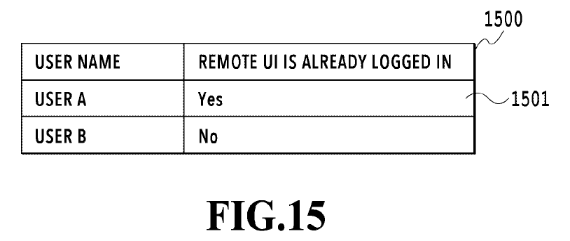

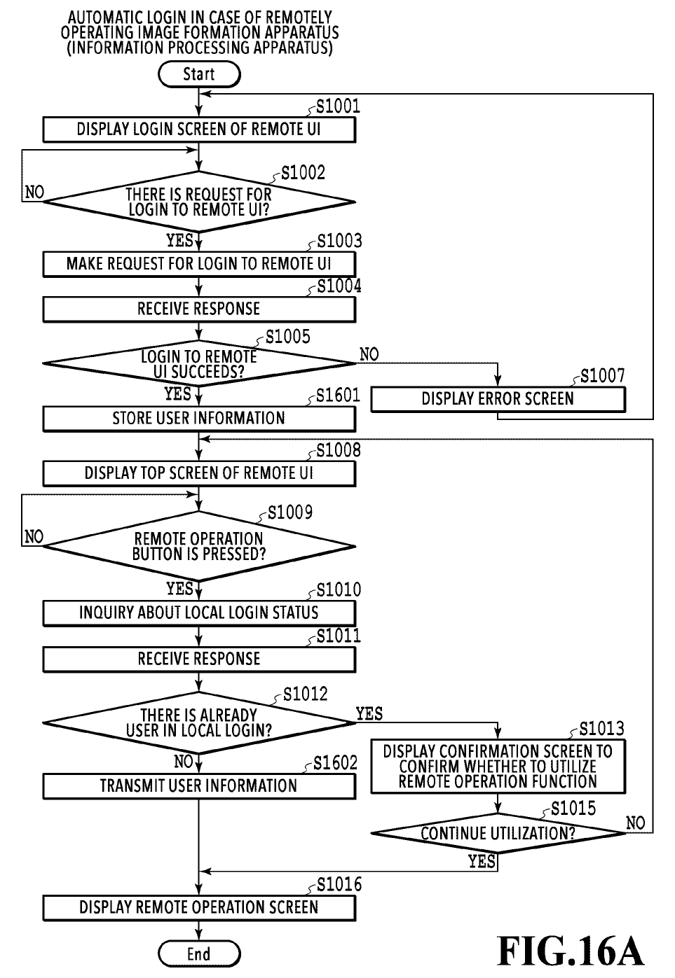

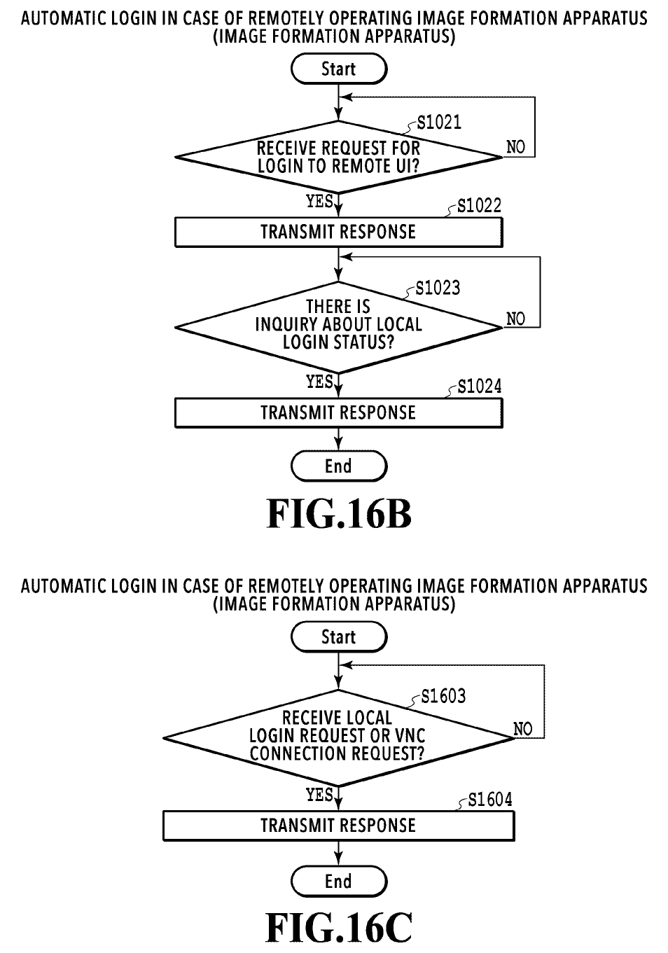

FIG. 15 is a diagram illustrating an example of a management table to manage the user name and a flag indicating whether the remote UI is already logged in. A management table 1500 illustrated in FIG. 15 is recorded in the ROM 204, the RAM 203, or the HDD 205 of the image formation apparatus 102. With reference to the management table 1500, it is indicated that the user A already logs into the remote UI, and the user B does not log into the remote UI yet. For example, information 1501 in the management table 1500 is updated in a case where the authentication unit 311 allows the login to the remote UI in S1021 in FIG. 16 or in a case where the web connection of the remote UI is disconnected.

FIG. 16 is a flowchart illustrating an example of processing executed by the information processing apparatus 101 or the image formation apparatus 102 in the present embodiment. Basic configurations of the information processing apparatus 101 and the image formation apparatus 102 in the present embodiment are similar to that in the first embodiment; for this reason, descriptions thereof are omitted. Processing from S1001 to S1005, S1007 to S1013, S1015, S1016, and S1021 to S1024 in FIG. 16 is similar to the processing denoted by the same reference numerals illustrated in FIG. 10 of the first embodiment; for this reason, descriptions thereof are omitted.

FIG. 16A is a flowchart illustrating an example of processing executed by the CPU 401 of the information processing apparatus 101 in the present embodiment as a function of the web browser 502. Hereinafter, a different point from the first embodiment is described.

In S1601, by the web browser 502, the CPU 401 stores the user name and the information indicating that the remote UI is already logged in that are inputted in S1002, and the processing proceeds to S1008. For example, the user name and the information indicating that the remote UI is already logged in are stored in a storage region such as the RAM 403 or the HDD 404 allocated for the web browser 502 or the system software 501. An example in which the user information formed of the user name and the information indicating that the remote UI is already logged in that are stored in S1601 is discarded in a timing of the disconnection of the web connection of the remote UI is described. Note that, even in a case where the web connection of the remote UI is disconnected, the user information may be held by the web browser 502 or the system software 501.

In S1602, by the web browser 502, the CPU 401 makes the request to the image formation apparatus 102 for the local login while including the user information that is the combination of the user name and the information indicating that the remote UI is already logged in that are stored in S1601, and the processing proceeds to S1016.

FIG. 16C is a flowchart illustrating an example of processing executed by the CPU 202 of the image formation apparatus 102 in the present embodiment as a function of the web server 330.

In S1603, by the web browser 502, the CPU 401 determines whether the local login request or the VNC connection request is received from the web browser 502. In S1603, by the web browser 502, if it is determined that the local login request or the VNC connection request is received from the web browser 502 (Yes), the CPU 401 allows the processing to proceed to S1604. In S1603, by the web browser 502, if it is determined that no local login request nor VNC connection request is received from the web browser 502 (No), the CPU 401 waits until the local login request or the VNC connection request is received. In the present embodiment, an example in which, in S1603, by the web server 330, the CPU 202 receives the local login request from the web browser 502 is described.

In S1603, by the web server 330, in a case where the local login request is received from the web browser 502, the CPU 202 makes a notification to the authentication unit 311 via the data conversion unit 340, the VNC server 320, and the event processing unit 307. The authentication unit 311 performs the user authentication based on the user name and the information indicating that the remote UI is already logged in that are the user information received from the web browser 502 and based on the management table 1500 illustrated in FIG. 15 and determines whether to allow the local login. Then, the authentication unit 311 passes the result of the user authentication to the web server 330.

In S1604, by the web server 330, the CPU 202 transmits the user authentication result received from the authentication unit 311 in S1603 to the web browser 502, which makes the local login request, as a response, and ends the present flow. Note that, the VNC connection processing and the displaying of the remote operation screen are similar to that in the first embodiment; for this reason, the description is omitted.

According to the present embodiment, it is unnecessary to store the combination of the user name and the password in the web browser 502 or the system software 501, and therefore it is possible to obtain a similar effect as that of the first embodiment while providing a more secure information processing apparatus.

### Third Embodiment

In the first embodiment, an example in which the confirmation screen 1300 is displayed on the web browser 502 in a case where there is already the user in the local login is described. In the present embodiment, an example in which the displaying of the confirmation screen 1300 is skipped in a case where the user logging in the remote UI and the user already in the local login are the same is described.

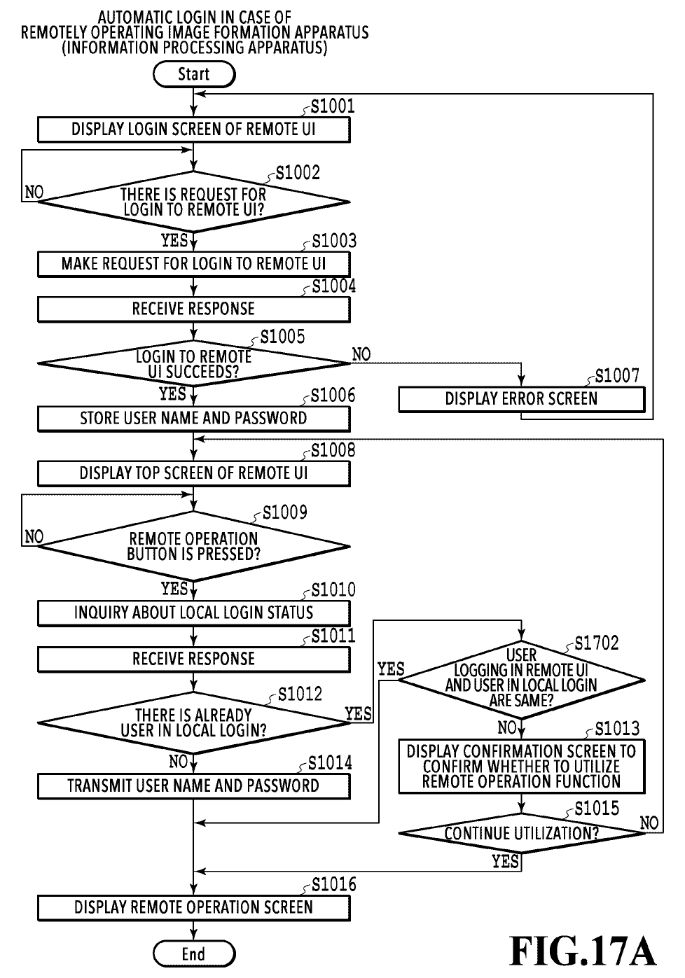

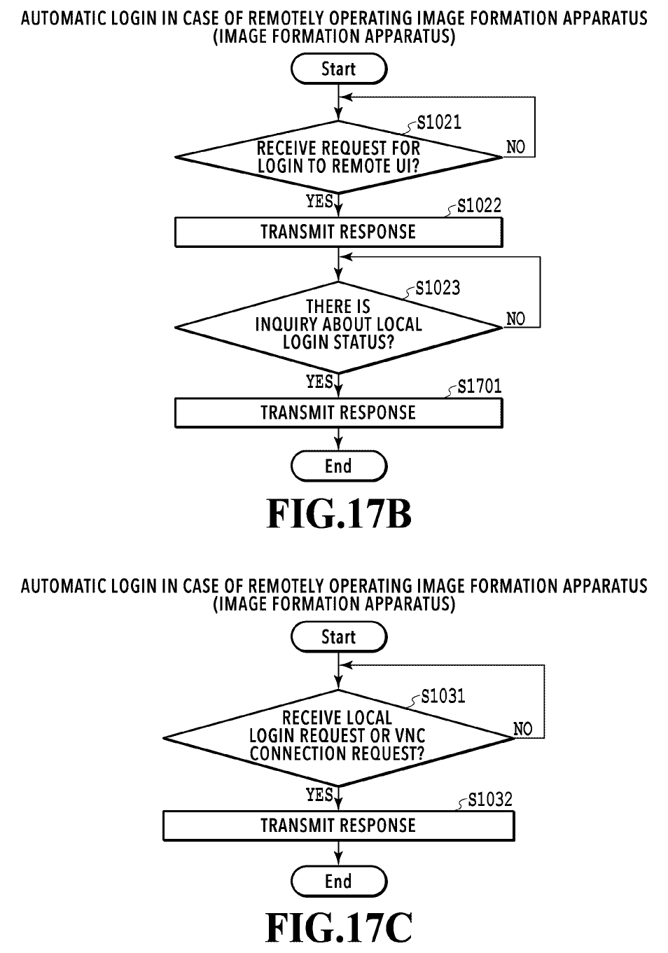

FIG. 17 is a flowchart illustrating an example of processing executed by the information processing apparatus 101 or the image formation apparatus 102 in the present embodiment. Basic configurations of the information processing apparatus 101 and the image formation apparatus 102 in the present embodiment are similar to that in the first embodiment; for this reason, descriptions thereof are omitted. Processing from S1001 to S1016, S1021 to S1023, S1031, and S1032 in FIG. 17 is similar to the processing denoted by the same reference numerals illustrated in FIG. 10 of the first embodiment; for this reason, descriptions thereof are omitted.

FIG. 17B is a flowchart illustrating an example of processing executed by the CPU 202 of the image formation apparatus 102 in the present embodiment as a function of the web server 330. Hereinafter, a different point from the first embodiment is described.

In S1701, by the web server 330, the CPU 202 transmits the determination result received from the authentication unit 311 in S1023 to the web browser 502, which makes the inquiry in S1023, as a response and ends the present flow.

In a case where there is already the user in the local login, and the user is the same as the user logging in the remote UI, in S1701, the CPU 202 transmits information indicating the users are similar to each other to the web browser 502. The user logging in the remote UI is the user who succeeds the login to the remote UI and who makes the inquiry about the local login status. In a case where there is already the user in the local login, and the user is different from the user logging in the remote UI, in S1701, the CPU 202 transmits information indicating that the users are different from each other and the screen data of the confirmation screen 1300 to the web browser 502. In a case where there is no user in the local login, in S1024, by the web server 330, the CPU 202 transmits information indicating that there is no user in the local login to the web browser 502.

FIG. 17A is a flowchart illustrating an example of processing executed by the CPU 401 of the information processing apparatus 101 in the present embodiment as a function of the web browser 502.

In S1702, by the web browser 502, if it is determined that the response result received in S1011 indicates that the user already in the local login is the same as the user logging in the remote UI (Yes), the CPU 401 allows the processing to proceed to S1016. Then, in S1702, by the web browser 502, the CPU 401 makes the request to the image formation apparatus 102 for the VNC connection. That is, in a case where the user already in the local login is the same as the user logging in the remote UI, the web browser 502 does not display the confirmation screen 1300. In S1702, by the web browser 502, if it is determined that the response result received in S1011 indicates that the user already in the local login is different from the user logging in the remote UI (No), the CPU 401 allows the processing to proceed to S1013.

According to the present embodiment, in a case where the user already in the local login matches the user logging in the remote UI, the displaying of the confirmation screen 1300 is skipped. Thus, even in a case where there is already the user in the local login, it is possible to lessen the operation load for the user and improve the convenience.

### Fourth Embodiment

In the first embodiment, an example in which, in a case where there is already the user in the local login, the image formation apparatus 102 executes the VNC connection processing of the information processing apparatus 101 while maintaining the local login state of the user is described. In the present embodiment, an example in which, in a case where there is already the user in the local login, the displaying of the confirmation screen 1300 is skipped after the local login state of the user transitions to the logout state.

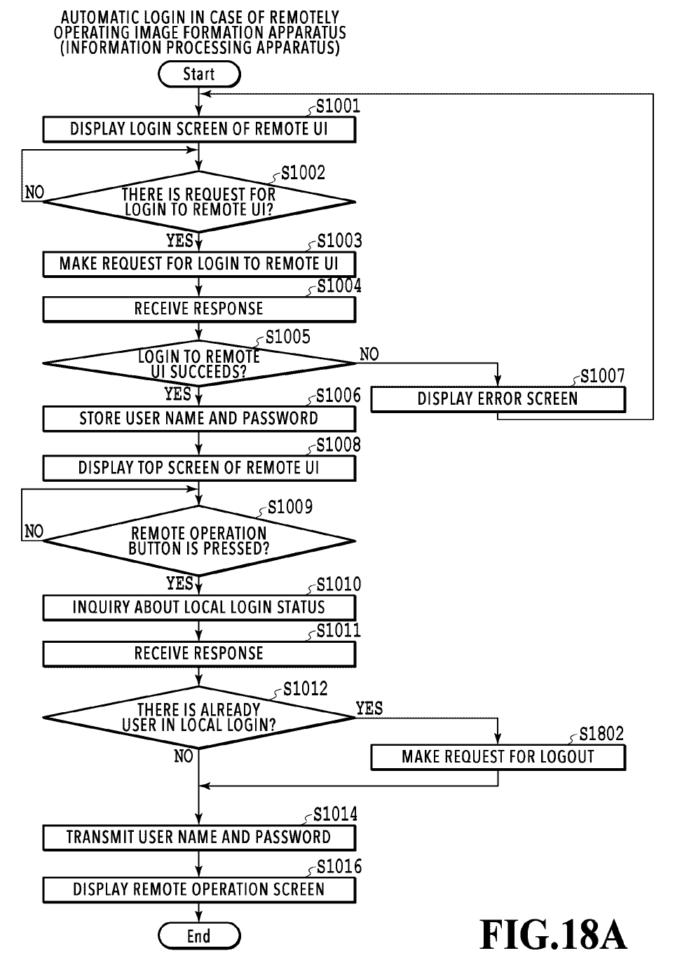

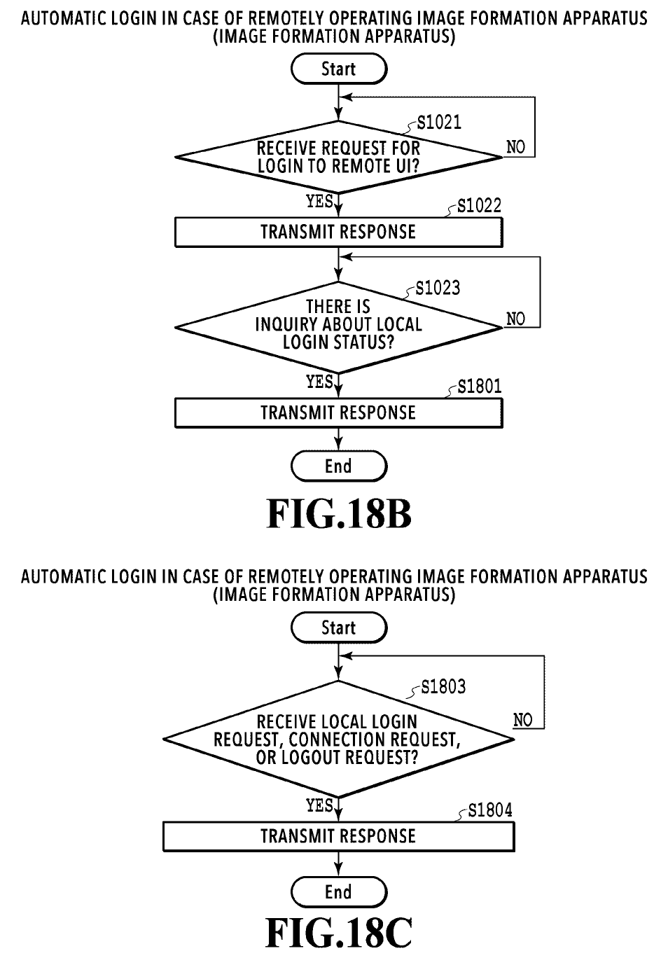

FIG. 18 is a flowchart illustrating an example of processing executed by the information processing apparatus 101 or the image formation apparatus 102 in the present embodiment. Basic configurations of the information processing apparatus 101 and the image formation apparatus 102 in the present embodiment are similar to that in the first embodiment; for this reason, descriptions thereof are omitted. Processing from S1001 to S1012, S1014, S1016, and S1021 to S1023 in FIG. 18 is similar to the processing denoted by the same reference numerals illustrated in FIG. 10 of the first embodiment; for this reason, descriptions thereof are omitted.

FIG. 18B is a flowchart illustrating an example of processing executed by the CPU 202 of the image formation apparatus 102 in the present embodiment as a function of the web server 330. Hereinafter, a different point from the first embodiment is described.

In S1801, by the web server 330, the CPU 202 transmits the determination result received from the authentication unit 311 in S1023 to the web browser 502, which makes the inquiry in S1023, as a response and ends the present flow.

In a case where there is already the user in the local login, in S1801, the CPU 202 transmits the information indicating that there is already the user in the local login to the web browser 502. In a case where there is no user in the local login, in S1801, by the web server 330, the CPU 202 transmits the information indicating that there is no user in the local login to the web browser 502.

FIG. 18A is a flowchart illustrating an example of processing executed by the CPU 401 of the information processing apparatus 101 in the present embodiment as a function of the web browser 502.

In S1802, by the web browser 502, the CPU 401 transmits a request to the image formation apparatus 102 for the logout. The logout request is a request to allow the login state of the user already in the local login to transition to the logout state. Then, in S1802, by the web browser 502, in a case where the CPU 401 receives a transition completion notification described later, the processing proceeds to S1014. That is, in a case where there is already the user in the local login in the present embodiment, the web browser 502 does not display the confirmation screen 1300.

FIG. 18C is a flowchart illustrating an example of processing executed by the CPU 202 of the image formation apparatus 102 in the present embodiment as a function of the web server 330.

In S1803, by the web browser 502, the CPU 401 determines whether the local login request, the VNC connection request, or the logout request is received from the web browser 502. In S1803, by the web browser 502, if it is determined that the local login request, the VNC connection request, or the logout request is received from the web browser 502 (Yes), the CPU 401 allows the processing to proceed to S1804. In S1803, by the web browser 502, if it is determined that the local login request, the VNC connection request, or the logout request is not received from the web browser 502 (No), the CPU 401 waits until the request is received.

In S1803, by the web server 330, in a case where the logout request is received from the web browser 502, the CPU 202 makes a notification to the authentication unit 311 via the data conversion unit 340, the VNC server 320, and the event processing unit 307. The authentication unit 311 performs processing of allowing the login state of the user being logging in to the logout state according to the logout request received from the web browser 502. Then, the authentication unit 311 passes the transition completion notification indicating that the transition to the logout state is completed to the web server 330.

In S1804, by the web server 330, the CPU 202 transmits the transition completion notification received from the authentication unit 311 in S1803 to the web browser 502, which makes the logout request, as a response and ends the present flow. Note that, the VNC connection processing and the displaying of the remote operation screen are similar to that in the first embodiment; for this reason, the description is omitted.

According to the present embodiment, in a case where there is already the user in the local login, the login state of the user transitions to the logout state. Then, the remote operation screen is displayed by making the local login request. Thus, it is possible to skip the displaying of the confirmation screen 1300, and therefore it is possible to lessen the operation load for the user and improve the convenience.

### Fifth Embodiment

In the above-described embodiment, an example in which the information processing apparatus 101 executes predetermined processing according to whether there is already the user in the local login is described. In the present embodiment, an example in which the user can set in advance the processing related to the local login executed by the information processing apparatus 101 is described.

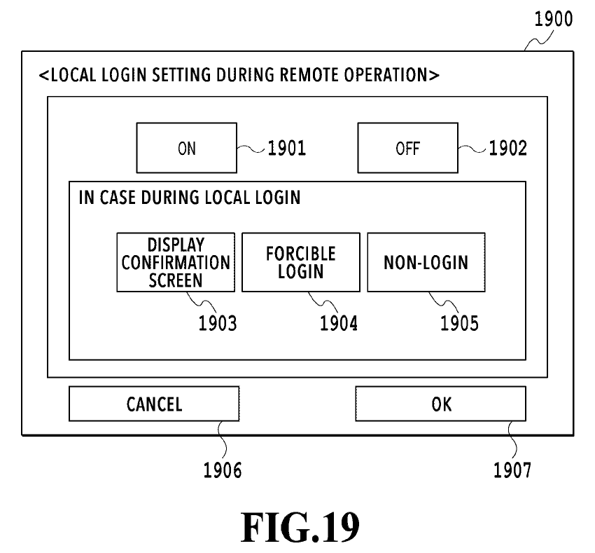

FIG. 19 is a diagram illustrating an example of a setting screen related to the local login during the remote operation. A setting screen 1900 illustrated in FIG. 19 is displayed by the CPU 202 of the image formation apparatus 102. The setting screen 1900 is provided with an ON button 1901, an OFF button 1902, a cancel button 1906, and an OK button 1907.

The OK button 1907 is a button to accept the determination of the setting contents corresponding to the button selected on the setting screen 1900. For example, once the OK button 1907 is pressed by the user in a state in which a forcible login button 1904 described later is selected, the CPU 202 of the image formation apparatus 102 saves a setting value corresponding to the forcible login button 1904 into the HDD 205.

The cancel button 1906 is a button to accept the non-reflection of the setting contents corresponding to the button selected on the setting screen 1900. Once the cancel button 1906 is pressed by the user, the CPU 202 of the image formation apparatus 102 closes the setting screen 1900.

The ON button 1901 is a button to accept the provision of the remote operation function without the local login operation by the user. Once the ON button 1901 is pressed, a setting button corresponding to the processing related to the local login executed by the information processing apparatus 101 during the remote operation is displayed. For example, as illustrated in FIG. 19, a confirmation screen display button 1903, the forcible login button 1904, and a non-login button 1905 are displayed. In the present embodiment, in S1024, the web server 330 refers to the setting contents set on the setting screen 1900 and transmits a response to the inquiry about the local login status to the web browser 502.

The confirmation screen display button 1903 is a button to accept the setting to display the confirmation screen 1300 by the web browser 502 in a case where there is already the user in the local login. In a case where a setting value corresponding to the confirmation screen display button 1903 is saved, and there is already the user in the local login, in S1024, the web server 330 transmits the screen data of the confirmation screen 1300 as a response to the inquiry made in S1023. Then, in S1013, the web browser 502 displays the confirmation screen 1300.

The forcible login button 1904 is a button to accept the setting to make the logout request by the web browser 502 of the information processing apparatus 101 in a case where there is already the user in the local login. In a case where a setting value corresponding to the forcible login button 1904 is saved, and there is already the user in the local login, in S1024, the web server 330 transmits the information indicating that there is already the user in the local login as a response. Then, in S1802, the web browser 502 makes the request to the image formation apparatus 102 for the logout.

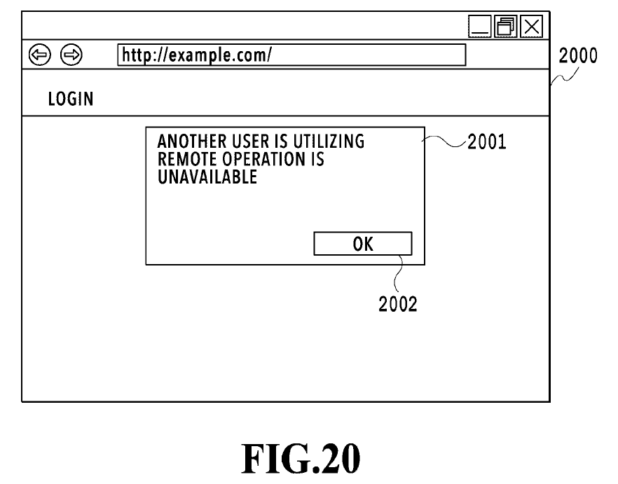

The non-login button 1905 is a button to accept the setting of not utilizing the remote operation function by the web browser 502 of the information processing apparatus 101 in a case where there is already the user in the local login. In a case where there is a setting value corresponding to the non-login button 1905 is saved, and there is already the user in the local login, in S1024, the web server 330 transmits screen data of a warning screen as illustrated in FIG. 20 as a response to the inquiry made in S1023. Then, the web browser 502 displays a received warning screen 2001. That is, in this case, the web browser 502 does not display the remote operation screen 1400. The warning screen 2001 is pop-up displayed on the web browser 502, for example.

FIG. 20 is a diagram illustrating an example of the warning screen displayed on the web browser 502 in the present embodiment. The warning screen 2001 illustrated in FIG. 20 displays a message indicating that the remote operation function cannot be utilized because there is already the user in the local login. For example, a message of "Another user is utilizing. Remote operation is unavailable." is displayed on the warning screen 2001. The warning screen 2001 is provided with an OK button 2002. Once the OK button 2002 is pressed, the web browser closes the warning screen 2001.

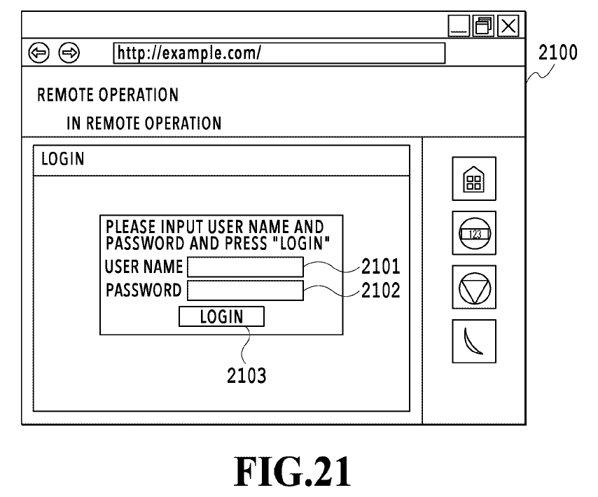

The OFF button 1902 is a button to accept the provision of the remote operation function by the local login operation by the user. In a case where a setting value corresponding to the OFF button 1902 is saved, and there is no user in the local login, in S1024, the web server 330 transmits the screen data of a local login screen as illustrated in FIG. 21 as a response to the inquiry made in S1023. Then, the web browser 502 displays a received local login screen 2100.

FIG. 21 is a diagram illustrating an example of the local login screen 2100 displayed on the web browser 502 in the present embodiment. The local login screen 2100 illustrated in FIG. 21 displays a user name input region 2101 and a password input region 2102. Additionally, the local login screen 2100 is provided with a login button 2103. The login button 2103 is a button to accept an instruction to transmit the local login request. Once the login button 2103 is pressed, the web browser 502 makes the request to the image formation apparatus 102 for the local login while including the user information for the local login inputted in the user name input region 2101 and the password input region 2102. Then, the authentication unit 311 determines whether to allow the local login based on the user information obtained via the event processing unit 307 and the authentication information registered in advance. Then, the web server 330 transmits the determination result obtained by the authentication unit 311 to the web browser 502 as a response to the local login request.

According to the present embodiment, it is possible to control the screen displaying by the information processing apparatus 101 according to the setting selected by the user. Thus, it is possible to improve the convenience.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-072472, filed April 24, 2025, which is hereby incorporated by reference herein in its entirety.

What is claimed is:

1. An information processing apparatus configured to be communicably connected with an image formation apparatus and including a web browser, comprising:
at least one memory and at least one processor which function as:
an acceptance unit configured to accept input of user information to the web browser for remote login to the image formation apparatus;
a transmission unit configured to perform control to transmit the user information accepted by the acceptance unit to the image formation apparatus for local login to the image formation apparatus that allows the remote login; and
a display control unit configured to perform control to display a first screen, which is a screen displayed on a display unit of the image formation apparatus that allows the local login based on the user information, on the web browser.

2. The information processing apparatus according to claim 1, wherein
the first screen is a screen displayed via a Virtual Network Computing (VNC) connection with the image formation apparatus.

3. The information processing apparatus according to claim 1, wherein
the user information includes a user name and a password that are used for user authentication for the remote login by the image formation apparatus, and
the transmission unit transmits the user name and the password to the image formation apparatus for the local login.

4. The information processing apparatus according to claim 1, wherein
the user information includes a user name and information indicating whether the remote login is performed that are used for user authentication for the remote login by the image formation apparatus, and
the transmission unit transmits the user name and the information to the image formation apparatus for the local login.

5. The information processing apparatus according to claim 1, wherein
the display control unit displays a second screen, which is a screen that can browse a state of the image formation apparatus in a case where the remote login succeeds, on the web browser, and
in a case where an operation is performed on the second screen, and there is no user in the local login, the first screen is displayed on the web browser.

6. The information processing apparatus according to claim 5, wherein
in a case where the operation is performed on the second screen, and there is already the user in the local login, the display control unit displays a confirmation screen, which is to confirm whether to display the first screen in a state in which the user is in the local login, on the web browser, and
the first screen is displayed on the web browser according to an operation performed on the confirmation screen.

7. The information processing apparatus according to claim 6, wherein
in a case where the operation is performed on the second screen, and the user who performs the local login and the user already in the local login are the same, the display control unit does not display the confirmation screen and performs control to display the first screen.

8. The information processing apparatus according to claim 5, wherein
in a case where an operation is performed the second screen, and there is already the user in the local login,
the transmission unit transmits the user information after a logout request to transition a login state of the user to a logout state is transmitted to the image formation apparatus, and
the display control unit performs the control.

9. The information processing apparatus according to claim 6, wherein
in the image formation apparatus, it is possible to perform setting to display the confirmation screen by the display control unit in a case where there is already the user in the local login, and
the display control unit performs the control in a case where the setting is performed on the image formation apparatus.

10. The information processing apparatus according to claim 8, wherein
in the image formation apparatus, it is possible to perform setting to allow the transmission unit to make the logout request in a case where there is already the user in the local login, and
the display control unit performs the control in a case where the setting is performed on the image formation apparatus.

11. The information processing apparatus according to claim 2, wherein
in the image formation apparatus, it is possible to perform setting of not utilizing a remote operation function by the VNC connection by the web browser in a case where there is already the user in the local login, and
the display control unit does not perform the control in a case where the setting is performed on the image formation apparatus.

12. A control method of an information processing apparatus configured to be communicably connected with an image formation apparatus and including a web browser, comprising:
accepting input of user information to the web browser for remote login to the image formation apparatus;
performing control to transmit the user information to the image formation apparatus for local login to the image formation apparatus that allows the remote login; and
performing control to display a first screen, which is a screen displayed on a display unit of the image formation apparatus that allows the local login based on the user information, on the web browser.

13. A non-transitory computer-readable storage medium storing a program for causing an information processing apparatus to execute a method, the information processing apparatus communicates with a printing apparatus and has a web browser, the method comprising:
accepting input of user information to the web browser for remote login to the image formation apparatus;
performing control to transmit the user information accepted in the accepting to the image formation apparatus for local login to the image formation apparatus that allows the remote login; and
performing control to display a first screen, which is a screen displayed on a display unit of the image formation apparatus that allows the local login based on the user information, on the web browser.
